(19) United States
(12) Patent Application Publication
(10) Pub. No.: US 2009/0059407 A1
(43) Pub. Date: Mar. 5, 2009

(54) COLOR WHEEL

(75) Inventors: YU-LUN HO, Tu-Cheng (TW); WEN-HSUAN CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/943,509

(22) Filed: Nov. 20, 2007

(30) Foreign Application Priority Data
Aug. 28, 2007 (CN) 200710201503.5

(51) Int. Cl. G02B 7/00

(52) U.S. Cl. 359/892; 359/891

(57) ABSTRACT

A color wheel includes a motor and a color filter. The motor includes a rotating casing and a rotating shaft protruding outward from a center of a side of the rotating casing. An external thread is formed on the rotating shaft. The color filter defines an internal thread. The color filter is engaged with the motor by engaging the external thread of the rotating shaft with the internal thread of the color filter.

### TECHNICAL FIELD

The present invention relates to the art of color wheels and, particularly, to a color wheel with small-size and simple configuration used in a projection display device.

### BACKGROUND

It is well known that color projectors such as digital light processing types use a color wheel. Usually the color wheel has color filters adhered to an end face of a rotating shaft of a motor.

A conventional color wheel includes a motor and a color filter. In general, the color filter is mounted on the motor by using an adhesive. However, during high-speed rotation of the color wheel, heat is rapidly conducted to the bonding ends between the color filter and the motor, and the heat can breakdown the adhesive. Thus, the engagement between the color filter and the motor is unreliable.

Another connection fashion is designed to overcome the above mentioned problem. Engagement between the color filter and the motor is obtained by use of a screw, bolt, or other securing element. However, such configuration requires a complicated, costly manufacturing process which results in a bulky color wheel suitable for slim and compact electronic products.

What is needed, therefore, is a color wheel that is both compact and economical to produce.

### SUMMARY

In accordance with a present embodiment, a color wheel includes a motor and a color filter. The motor includes a body, a rotating casing with a rotating shaft protruding outward from a center of a side of the rotating casing. An external thread is formed on the rotating shaft. The color filter defines an internal thread for engaging with the threaded the rotating shaft.

Other advantages and novel features will be drawn from the following detailed description of at least one preferred embodiment, when considered in conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the color wheel. Moreover, in the drawings, like reference numerals designate corresponding parts throughout the several views.

FIG. 1 is an exploded, cross-sectional view of a color wheel in accordance with a first present embodiment;

FIG. 2 is an assembled view of FIG. 1;

FIG. 3 is a cross-sectional view of a color wheel in accordance with a second present embodiment;

FIG. 4 is an exploded, cross-sectional view of a color wheel in accordance with a third present embodiment; and

FIG. 5 is an exploded, cross-sectional view of a color wheel in accordance with a fourth present embodiment.

### DESCRIPTION OF EMBODIMENTS

Embodiments of the present color wheel will now be described in detail below with reference to the drawings.

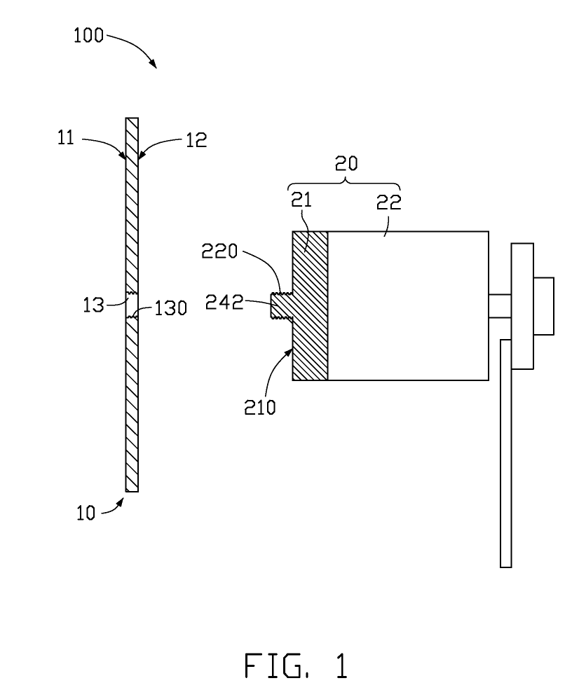

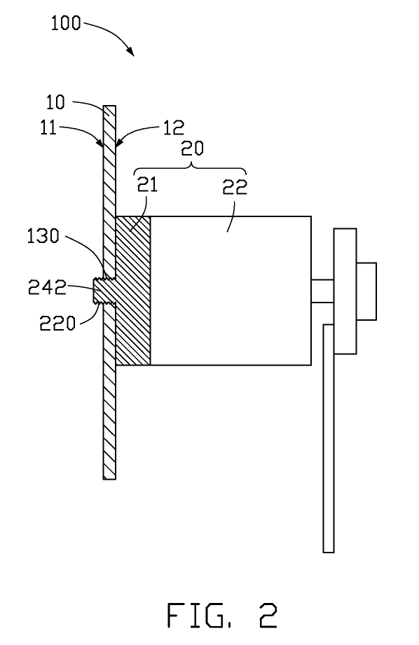

Referring to FIGS. 1-2, a color wheel 100, in accordance with a first preferred embodiment, includes a color filter 10 and a motor 20.

The color filter 10 has a transparent plate-configuration, beneficially, made from glass or quartz. The color filter 10 defines a first surface 11, a second surface 12 opposite to the first surface 11, and a through hole 13 formed in the middle thereof and through the first surface 11 and the second surface 12. An internal thread 130 is formed on the inner lateral sides thereof. The first surface 11 is composed of three or more filter sectors of red, green and blue, while the second surface 12 is arranged adjacent to the motor 20.

The motor 20 has a body 21, a rotating casing 22 with a rotating shaft 242 aligned with the center axis of the rotating casing 22 protruding from a side 210. The side 210 is adjacent to the second surface 12 of the color filter 10. The diameter of the rotating shaft 242 is equal to that of the through hole 13 of the color filter 10, while the length of the rotating shaft 242 along the center axis of the rotating casing 22 is greater than that of the through hole 13. An external thread 220 is formed on the rotating shaft 242, beginning at or adjacent to the side 210. When assembling the color filter 10 and the motor 20, the rotating shaft 242 of the motor 20 is screwed into the through hole 13, thereby reliable engagement between the color filter 10 and the motor 20 is obtained.

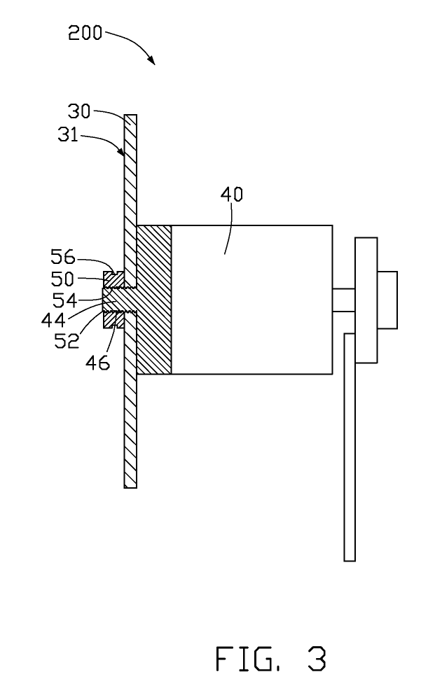

Referring to FIG. 3, a color wheel 200, in accordance with a second preferred embodiment, is similar to the color wheel 100 of the first embodiment. In this embodiment, the color wheel 200 further includes a positioning plate 50 mounted on a rotating shaft 44 of a motor 40 and attached on a first surface 31 of a color filter 30, thereby the color filter 30 is positioned between the positioning plate 50 and the motor 40. The positioning plate 50 is ring-shaped and defines an opening 52 corresponding to the rotating shaft 44 of the motor 40. The diameter of the opening 52 is approximately equal to the diameter of the rotating shaft 44. A second internal thread 54 is formed on the inner lateral sides thereof engaging with the corresponding external thread 46 of the rotating shaft 44. On the periphery of the positioning plate 50, a recess 56 with a balancing device (not shown) that can adjustably balance the color wheel 200 during high-speed rotation is formed. Other configurations of the second embodiment are the same as that of the first embodiment, and so are not described in detail.

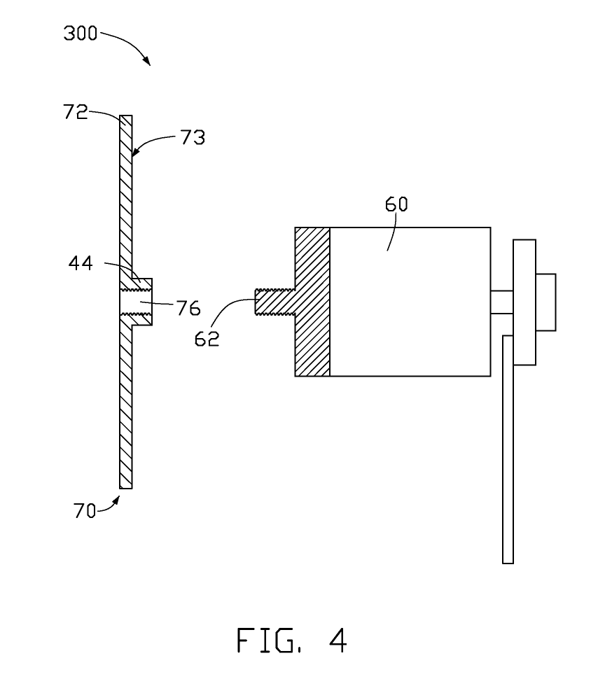

Referring to FIG. 4, a color wheel 300, in accordance with a third preferred embodiment, is similar to the color wheel 100 of the first embodiment. In this embodiment, a color filter 70 includes a base plate 72 and a protrusion 44 peripherally extending from the center of a second surface 73 of the base plate 72 toward to a rotating shaft 62 of a motor 60. An opening 76 is formed through the base plate 72 and the protrusion 44 along the center axis of the rotating shaft 62. The diameter of the opening 76 is equal to that of the rotating shaft 62, but less than that of the protrusion 44. Other configurations of the third embodiment are the same as that of the first embodiment, and so are not described in detail.

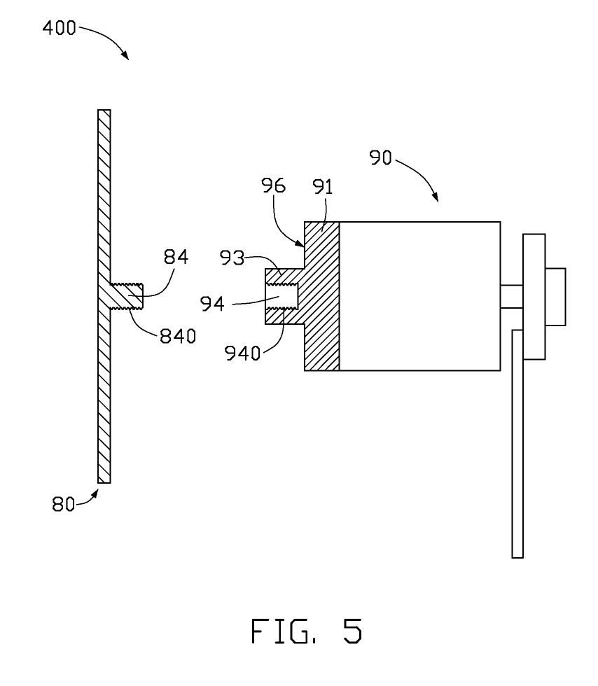

Referring to FIG. 5, a color wheel 400, in accordance with a fourth preferred embodiment, is similar to the color wheel 300 of the third embodiment. In this embodiment, an external thread 840 is formed on the a protrusion 84 of a color filter 80 along the center axis of a rotating shaft 93. The rotating shaft 93 of a motor 90 defines a hole 94 extending from a distal side near the protrusion 84 of the color filter 80 toward a side 96 of a rotating casing 91. The diameter of the protrusion 84 is equal to that of the hole 94, and the length of the protrusion 84 along the center axis of the rotating shaft 93 is equal to that of the groove 94. An internal thread 940 is formed in the hole 94 to engage with the external thread 840 of the color filter 80, thereby reliable engagement between the color filter 80 and the motor 90 is also obtained. Other configurations of the fourth embodiment are the same as that of the first embodiment, and so are not described in detail.

In the color wheels, the engagement between the color filter and the motor is obtained by threaded engagement, rather than by adhesive or fasteners. Therefore, the manufacturing costs are reduced, and assembly is more convenient, and the color wheels can be made having a smaller size allowing for smaller electronic devices utilizing same.

Although the present invention has been described with reference to particular embodiments, it is not to be construed as being limited thereto. Various alterations and modifications can be made to the embodiments without in any way departing from the scope or spirit of the present invention as defined in the appended claims.

What is claimed is:

1. A color wheel comprising:
a motor having a rotating casing with a side and a rotating shaft protruding from the center of the side thereof, a first thread formed on one of an interior and exterior of the rotating shaft along the center axis thereof;
a color filter defining a second thread to engage with the first thread, thereby the color filter is mounted on the motor.

2. The color wheel as claimed in claim 1, wherein the color filter defines a first surface, a second surface opposite to the first surface, and a through hole formed in the middle thereof and through the first surface and the second surface, the second thread is an internal thread formed on the inner lateral sides thereof, the first surface including a red filter sector, a green filter sector and a blue filter sector, and the second surface arranged adjacent to the motor.

3. The color wheel as claimed in claim 2, wherein the diameter of the rotating shaft is equal to that of the through hole of the color filter, while the length of the rotating shaft along the center axis of the rotating casing is greater than that of the through hole, and the first thread is an external thread formed on the motor, adjacent to the side.

4. The color wheel as claimed in claim 3, further comprising a positioning plate mounted on the rotating shaft of the motor and attached on the first surface of the color filter.

5. The color wheel as claimed in claim 4, wherein the positioning plate is ring-shaped and defines an opening corresponding to the rotating shaft of the motor.

6. The color wheel as claimed in claim 5, wherein the diameter of the opening is approximately equal to the diameter of the rotating shaft, and a third internal thread is formed on the inner lateral sides engaging with the external thread of the rotating shaft.

7. The color wheel as claimed in claim 6, wherein on the periphery of the positioning plate, a recess with a balancing device that can adjustably balancing the color wheel during high-speed rotation.

8. The color wheel as claimed in claim 1, wherein the color filter includes a base plate and a protrusion peripherally extending from the center of the base plate toward the rotating shaft of the motor.

9. The color wheel as claimed in claim 8, wherein an opening is formed through the base plate and the protrusion along the center axis of the rotating shaft.

10. The color wheel as claimed in claim 9, wherein the diameter of the opening is equal to that of the rotating shaft, but less than that of the protrusion.

11. The color wheel as claimed in claim 8, wherein the second thread is an external thread formed on the periphery of the protrusion along the center axis of the rotating shaft.

12. The color wheel as claimed in claim 11, wherein the rotating shaft defines a hole extending from a distal side near the protrusion toward the side of the rotating casing.

13. The color wheel as claimed in claim 12, wherein the diameter of the protrusion is equal to that of the hole, and the length of the protrusion along the center axis of the rotating shaft is equal to that of the hole.

14. The color wheel as claimed in claim 13, wherein the first thread is an internal thread formed on the inner lateral sides of the hole along the center axis of the rotating shaft engaging with the second thread of the color filter.
